(19) United States
(12) Patent Application Publication
(10) Pub. No.: US 2018/0152217 A1
(43) Pub. Date: May 31, 2018

(54) MOBILE DEVICE CASE WITH OPTICAL LENS FOR WET ENVIRONMENTS

(71) Applicant: LASO Technologies, LLC, Cheyenne, WY (US)

(72) Inventors: Andrew Laird, Boston, MA (US); Matthew Andon, Charlestown, MA (US)

(73) Assignee: LASO Technologies, LLC, Cheyenne, WY (US)

(21) Appl. No.: 15/567,215

(22) PCT Filed: Apr. 19, 2016
(86) PCT No.: PCT/US16/28202

§ 371 Date: Oct. 17, 2017

Related U.S. Application Data
(60) Provisional application No. 62/153,002, filed on Apr. 27, 2015.

(51) Int. Cl. H04B 1/3888; H04N 5/232

(52) U.S. Cl. CPC H04B 1/3888; H04B 2001/3894; H04N 5/23245; H04N 5/23216

(57) ABSTRACT

A device case including a top portion and a bottom portion, wherein at least one of the top portion and the bottom portion include a gasket configured to sealingly contact the top portion and the bottom portion, and a button, which is configured to sealingly extend into the at least one of the top portion and the bottom portion; and a clasp, which is configured to reversibly hold the top portion and the bottom portion in a closed configuration.

### BACKGROUND

### (1) Field

This disclosure relates to a case for a mobile device suitable for use in a wet environment or underwater.

### (2) Description of the Related Art

A growing variety of mobile devices include the functionality of a camera. It would be desirable to use mobile devices for photography or videography in wet environments or underwater. However, many such mobile devices are not compatible with water, must be kept dry, or are unable to resist water below a certain depth. Therefore, there remains a need for products which allow the use of mobile devices in wet environments or underwater.

### SUMMARY

Disclosed is a device case including: a top portion and a bottom portion, wherein at least one of the top portion and the bottom portion includes a gasket configured to sealingly contact the top portion and the bottom portion, and a button, which is configured to sealingly extend into the at least one of the top portion and the bottom portion; and a clasp, which is configured to reversibly hold the top portion and the bottom portion in a closed configuration.

Also disclosed is a method of operating a device, the method including: disposing a device in the device case; and actuating the button from a rest position to an actuated position to actuate the device.

Also disclosed is a system including: the device case; and a device.

Also disclosed is a device case including: a top portion and a bottom portion, wherein at least one of the top portion and the bottom portion includes a gasket configured to sealingly contact the top portion and the bottom portion, and a first button and a second button, each of which is configured to independently sealingly extend into the at least one of the top portion and the bottom portion; a clasp, which is configured to reversibly hold the top portion and the bottom portion in a closed configuration; a lock, which is configured to lock the clasp; a hinge, which hingably connects the top portion and the bottom portion; an optical lens disposed in at least one of the top portion and the bottom portion; and a mounting arm disposed on a side of the device case, wherein the device case is watertight to a depth of at least 30 meters.

### BRIEF DESCRIPTION OF THE DRAWINGS

The above and other aspects, advantages and features of this disclosure will become more apparent by describing in further detail exemplary embodiments thereof with reference to the accompanying drawings, in which:

FIG. 1 is a top perspective view of an embodiment of a device compatible for use with the device case;

FIG. 2 is a bottom perspective view of an embodiment of a device compatible for use with the device case;

FIG. 3 is a top perspective view of an embodiment of a device case in a closed configuration;

FIG. 4 is a bottom perspective view of an embodiment of the device case in a closed configuration;

FIG. 5 is a top perspective view of an embodiment of the device case in an open configuration;

FIG. 6 is a bottom perspective view of an embodiment of the device case in an open configuration;

FIG. 7 is a bottom perspective view of an another embodiment of the device case;

FIG. 8 is a bottom perspective view of yet another embodiment of the device case;

FIG. 9 is a top perspective view showing an embodiment of the device case and an exploded view of an embodiment of a button;

FIG. 10 is a bottom perspective view of an embodiment of the device case in a closed configuration;

FIG. 11 is a top perspective view of an embodiment of the device case including a device in an open configuration;

FIG. 12 is a top perspective view of an embodiment of the device case including a device in a closed configuration; and

FIG. 13 is a top perspective view of an embodiment of an interchangeable top portion of the device case compatible for use with a touch screen of the device.

### DETAILED DESCRIPTION

Disclosed is a device case comprising: a top portion and a bottom portion, wherein at least one of the top portion and the bottom portion comprises a gasket configured to sealingly contact the top portion and the bottom portion, and a button, which is configured to sealingly extend into the at least one of the top portion and the bottom portion; and a clasp, which is configured to reversibly hold the top portion and the bottom portion in a closed configuration.

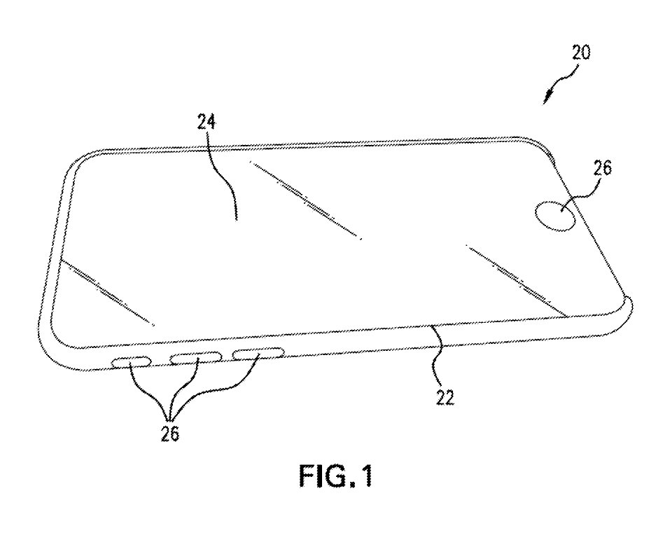

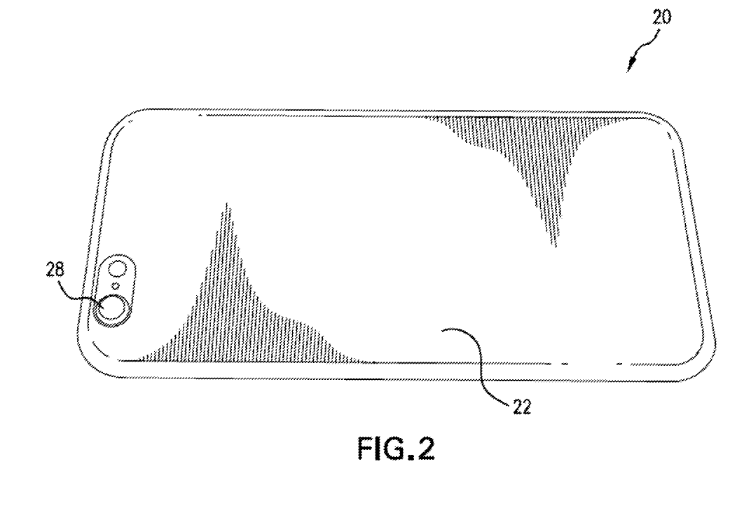

With reference now to FIGS. 1 and 2, an example of a device 20 is illustrated. The device 20 includes a body 22 and at least one screen 24 for displaying information to a user. The screen 24 may, but need not be a touch-screen, which is responsive to the application of pressure thereto by a user. The device 20 may additionally include one or more contacts 26 (e.g. buttons), disposed on any of a plurality of surfaces of the device 20. The contacts 26 may include a power button and a volume button, and may be operable to scroll or make selections related to settings or operation of the device 20. In the illustrated, non-limiting embodiment, the device includes a camera lens 28 (see FIG. 2) such that the device 20 is operable to take at least one of a photograph and a video. The device 20 illustrated and described herein is intended as an example only. It should be understood that any suitable type of device, such as a mobile phone, a tablet, and a personal digital assistant for example, is considered within the scope of the disclosure.

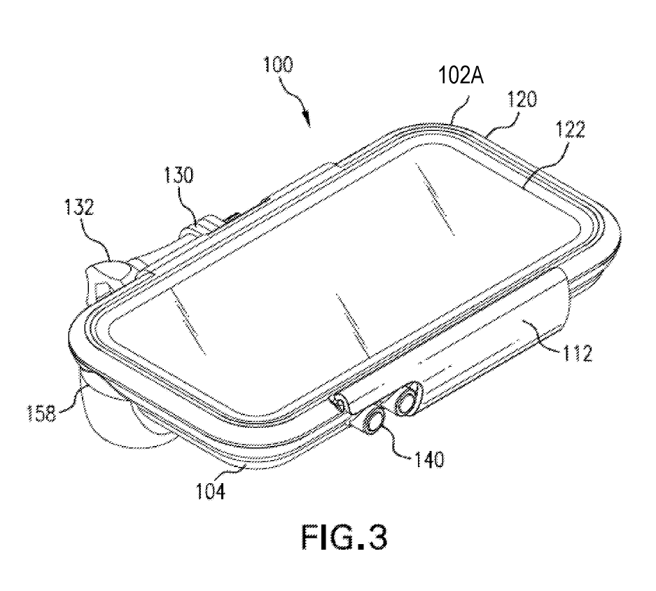

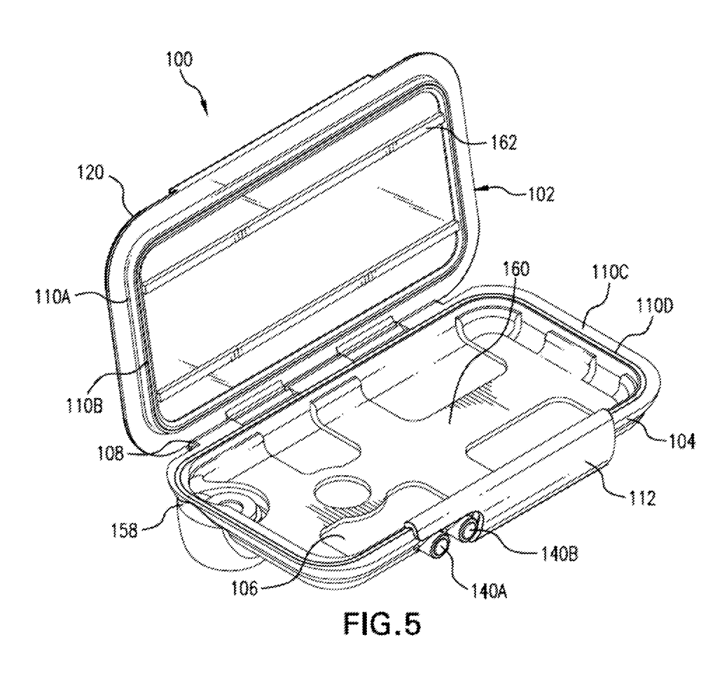

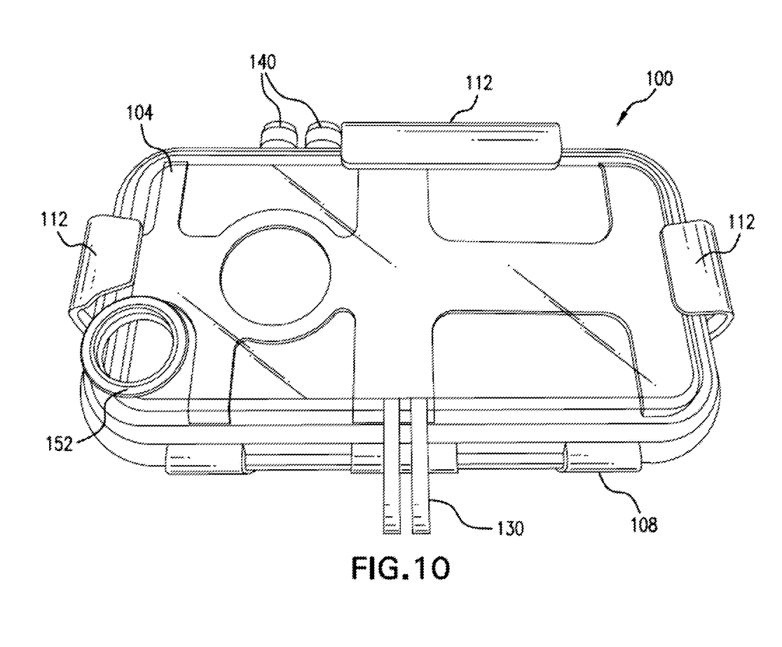

With reference now to FIGS. 3-13, various embodiments of the device case 100 are illustrated. The device case 100 includes a complementary top portion 102 and bottom portion 104 which are configured to cooperate with one another to contain a device 20, such as a mobile device including a camera, for example as shown in FIGS. 1 and 2, within a cavity 106 defined between the top and bottom portions 102 and 104. In an embodiment, the cavity 106 (best shown in FIG. 5) has a shape and size substantially similar to that of the device intended to be received therein.

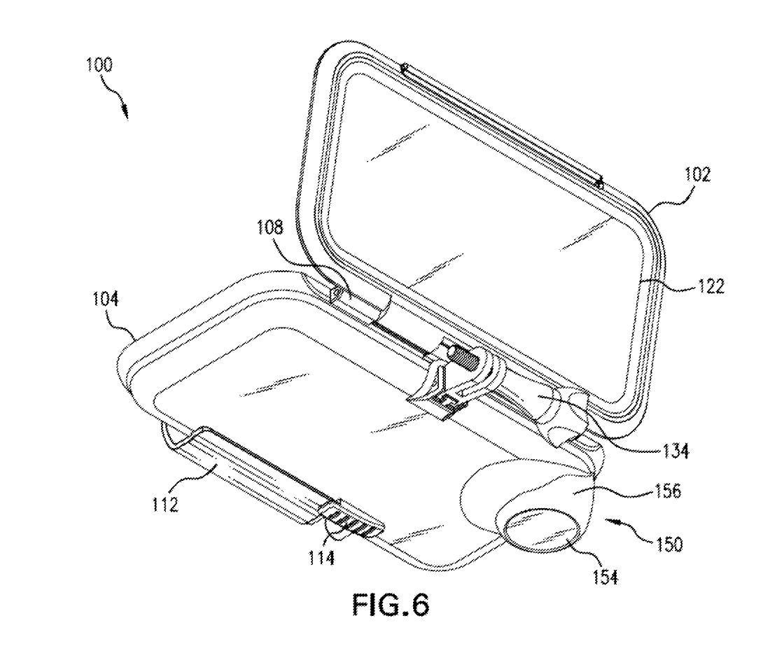

The top portion 102 and the bottom portion 104 are movable relative to one another, for example between an open configuration (FIG. 5) and a closed configuration (FIG. 3) to allow a user to easily access the cavity 106 to install a device 20 therein or remove a device 20 therefrom. In the closed configuration, the top portion 102 and the bottom portion 104 are arranged in a substantially overlapping configuration. A hinge 108 may be used to rotatably connect the top portion 102 and the bottom portion 104. In the illustrated, non-limiting embodiment of FIG. 6, the hinge 108 is arranged adjacent a side of the device case 100 to hingably connect the top portion 102 and the bottom portion 104 to facilitate opening of the device case 100 in a manner similar to a clam shell. The hinge 108 illustrated and described herein is intended as an example only. It should be understood that other types of mechanisms may be used to movably couple the top and bottom portions 102 and 104 of the device case 100. Further, embodiments where the top portion 102 is wholly separable from the bottom portion 104 are also considered within the scope of the disclosure.

At least one of the top portion 102 and the bottom portion 104 includes a gasket 110. The gasket 110 may be positioned on a surface of one or both of the top and bottom portions 102 and 104 and adjacent the cavity 106, and is configured to provide a watertight seal between the top portion 102 and the bottom portion 104 when the case is in the closed configuration. In an embodiment, both the top portion 102 and the bottom portion 104 each independently comprise a gasket 100, such as a primary gasket and a secondary gasket for example, to provide additional protection from the ingress of water. As shown in FIG. 5, the top portion 102 may comprise a first gasket 110A and a second gasket 110B, and the bottom portion 104 may comprise a third gasket 110C and a fourth gasket 110D. However, any of the first gasket 110A, second gasket 110B, third gasket 110C and fourth gasket 110D may be omitted if desired. A device case 100 having any suitable number of gaskets 110 is considered within the scope of the disclosure.

When the device case 100 is in a closed configuration, the gasket 110 is configured to create a water-tight seal. In an embodiment, the at least one gasket 110 is configured to maintain a watertight seal between the top portion 102 and bottom portion 104 from a depth of about 0 meters (i.e., splash protection) to a depth of about 50 meters, a depth of about 0.0001 meter to a depth of about 30 meters, a depth of about 0.001 meter to a depth of about 25 meters, a depth of about 0.01 meter to a depth of about 20 meters, a depth of about 0.1 meter to a depth of about 15 meters, or a depth of about 0.5 meter to a depth of about 5 meters, when the device case 100 is in a closed configuration. In an embodiment, the gasket 110 maintains a watertight seal between the top portion 101 and the bottom portion 104 to a depth of 50 meters, a depth of at least 30 meters, or to a depth of 2 meters when the device case 100 is in a closed configuration.

The at least one gasket 110 may comprise any suitable material, and in an embodiment comprises a compliant or elastomeric material. Suitable materials for the gasket 110 effectively prevent moisture, water, or other liquids and fluids from reaching the internal cavity 106 of the device case 100 when the device case 100 is closed. Representative materials for the gasket 110 include a silicone, a nitrile, nitrile butadiene, a polyacrylate acrylic rubber, a flouroelastomer, a polyurethane, a polyethylene, a polypropylene, a polypropylene-ethylene propylene dienene monomer, a butadiene, a styrene butadiene, a chlorosulfonate, a neoprene, butyl rubber, ethylene propylene, an ethylene propylene dienene monomer rubber (EPDM), a polyisoprene, polybutadiene, chloroprene, or combination thereof. Silicone, or SANTOPRENE which is available from Exxon Mobil, and Milastomer available from Mitsu Chemicals, which are also referred to as thermoplastic vulcanizates, are mentioned.

At least one clasp 112, movable between a first, open position and a second, closed position may be configured to selectively retain the top portion 102 and the bottom portion 104 in a closed configuration. Each clasp 112 may be independently connected to one of the top portion 102 and the bottom portion 104, and may be configured to rotate and engage the other of the top portion 102 and the bottom portion 104. Any suitable type of clasp 112 is considered within the scope of the disclosure, and in some embodiments, the one or more clasps 112 may be configured to restrict movement of the top portion 102 relative to the bottom portion 104, and also apply a sealing force thereto, such as via a cam surface for example.

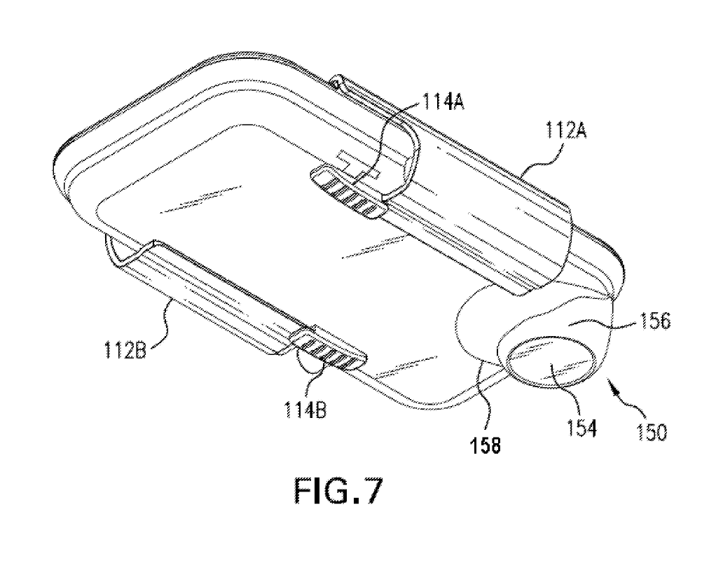

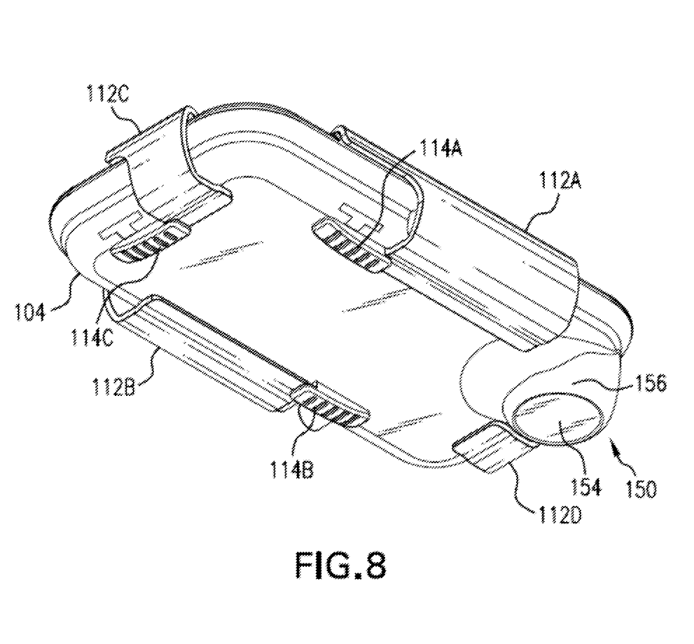

In the non-limiting embodiment illustrated in FIGS. 1-4, the device case 100 includes a single clasp 112 arranged opposite the hinge 108 and coupling the top and bottom portions 102 and 104. However, in other embodiments, the device case 100 may include a plurality of clasps 112, such as between 1 and 10 clasps, between 2 and 8 clasps, or between 3 and 7 clasps for example. The plurality of clasps 112 may be arranged on the same side or on different sides of the case 100. As shown in FIG. 7, the device case 100 may include a first clasp 112A and a second clasp 112B, for example arranged on opposite (shown) or adjacent sides of the case 100. In another example, the device case 100 includes first, second, third, and fourth clasps 112A-112D, as shown in FIG. 8. The clasps 112 may be disposed on a first, second, third, and fourth side of the top portion 102 and/or the bottom portion 104, respectively.

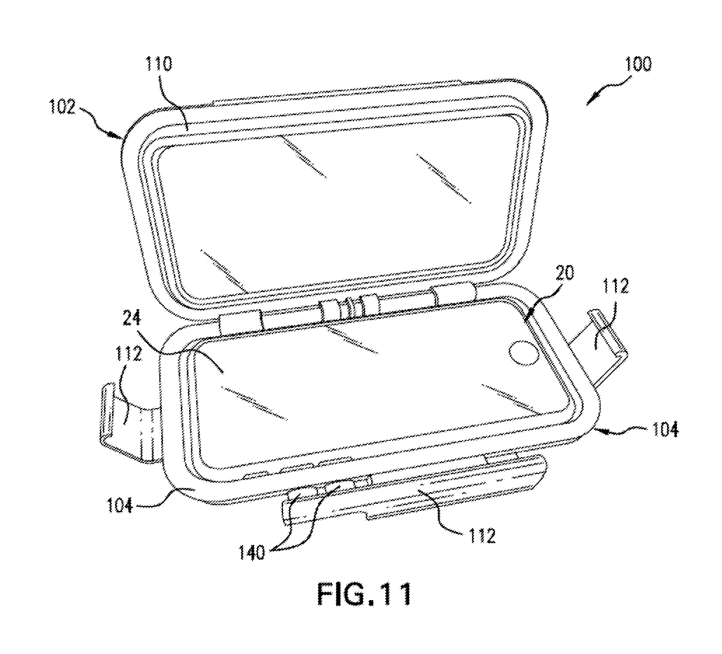

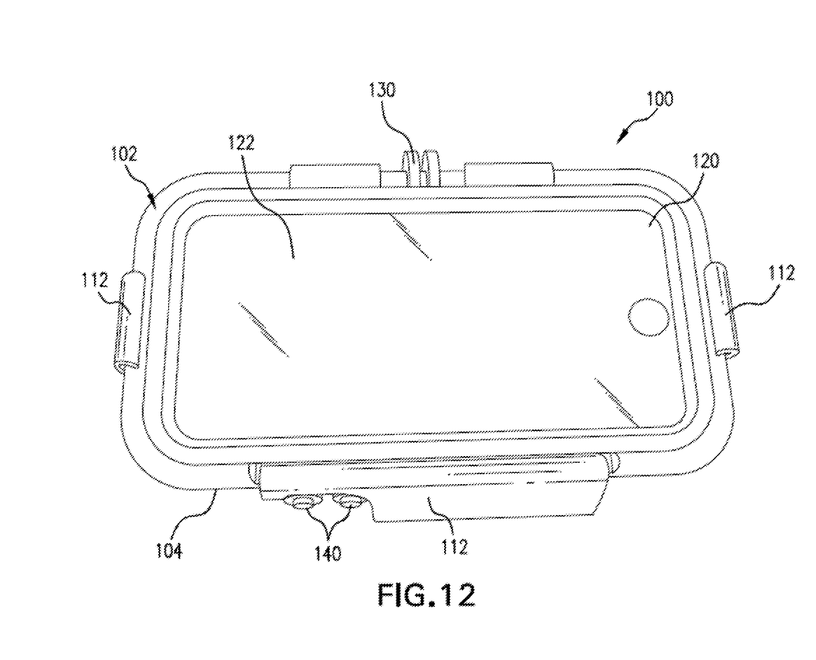

In yet another embodiment, illustrated in FIGS. 11 and 12, the device case 100 includes a first clasp 112A and a second clasp 112B positioned at a first side and at a second side, respectively, which is opposite the first side, of the top portion 102 or the bottom portion 104. The device case 100 further includes a third clasp 112C arranged at a third side of the top portion 102 or the bottom portion 104, and opposite a hinge 108. In addition, the plurality of clasps 112 may be substantially identical, or may be different. For example, the dimensions of each clasp 112 may be independently selected. Referring again to the non-limiting embodiment of FIGS. 11 and 12, the first clasp 112A and the second clasp 112B can be the same size, and the size of the first and second clasps 112A, 112B can be different than the size of a third clasp 112C of the device case 100.

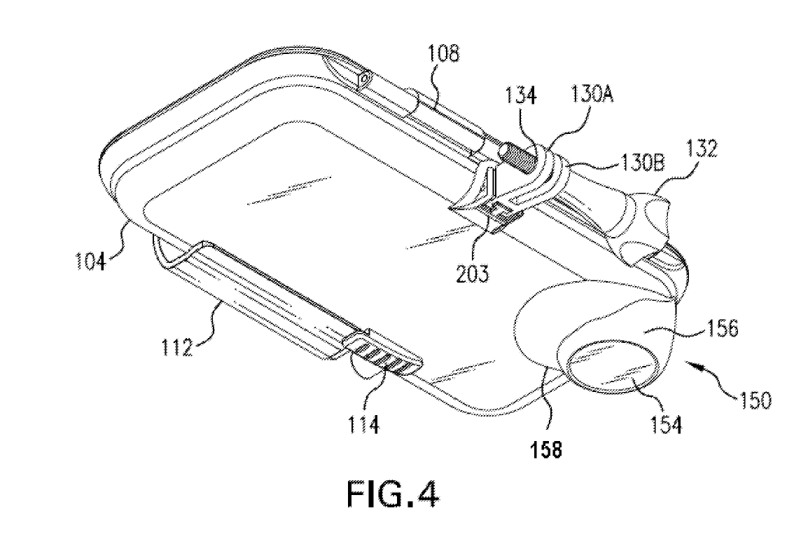

Referring now to FIGS. 4 and 6-8, a lock 114 may be provided to engage and maintain the clasp 112 in the second, closed position until deliberately opened by the user, such as by first disengaging the lock 114 from the clasp 112 before moving the clasp 112 to an open position for example. The lock 114 acts as a safety mechanism to ensure that the clasp 112, and therefore the device case 100, remains in a closed configuration and is not accidentally opened, thereby avoiding unintentional exposure of a device 20 contained therein to water or another fluid, for example. In the illustrated, non-limiting embodiment of FIG. 4, the lock 114 is slidingly affixed to one of the top portion 102 and the bottom portion 104. The lock 114 is configured to slide towards the clasp 112 until it overlaps with the clasp 112 sufficiently to securely hold the clasp 112 in a closed configuration and similarly slides in a direction out of contact with the clasp 112, such that the clasp 112 may be transformed to an open position.

In embodiments of the device case 100 including a plurality of locks 114, each lock 114 may be independently associated with a clasp 112, such as lock 114 as shown in FIG. 4, which is configured to lock the clasp 112. In an embodiment, the device case 100 includes a lock 114 associated with each clasp 112. For example, the device case 100 in FIG. 7 includes first and second clasps 112A, 112B and corresponding first and second locks 114A, 114B, and the device case 100 of FIG. 8 includes first, second, and third clasps 112A, 112B, 112C, and corresponding first, second, and third locks 114A, 114B, 114C, each lock 114 being configured to retain a corresponding clasp 112 in a closed position. Embodiments including a plurality of locks 114 associated with each clasp 112 or a lock 114 associated with multiple clasps 112 are also considered within the scope of the disclosure.

The top portion 102 of the device case 100 comprises a frame 120 and a window 122 disposed in the frame 120. At least one of the top portion 102 and the bottom portion 104 may comprise one or more suitable materials, such as a metal, a polymeric material, or a combination thereof for example. Representative metals include aluminum, magnesium, a steel such a corrosion resistant steel, titanium, or a combination thereof. Representative polymeric materials for the frame 120 include acrylonitrile butadiene styrene (ABS), polypropylene, polyethylene, acetal copolymer, acrylic, nylon, polycarbonate, polyamide, polystyrene, polyvinyl chloride, or a combination thereof. A combination comprising at least one of the foregoing may be used. In an embodiment, at least one of the top portion 102 and the bottom portion 104 comprises a polycarbonate. In another embodiment at least one of the top portion 102 and the bottom portion 104 comprises an acrylonitrile-butadiene-styrene polycarbonate blend.

The window 122 is configured to provide a user with visual, and optionally, touch access to a display and/or touch screen of a device 20 housed within the cavity. The window 122 may comprise any suitable material, such as a partially or fully transparent material for example. Representative polymeric materials for the window 122 include polycarbonate, acrylic, or any combination thereof.

In an embodiment, a portion of the device case 100, for example window 122, comprises a touch-screen compatible material, such as a touch sensitive glass for example, which allows for manipulation of and interaction with an adjacent screen 24 of a device 20 enclosed within the device case 100. The touch sensitive glass or other touch-screen compatible material is configured to transmit a user's touch commands to the surface of the adjacent screen 24 of the enclosed device 20.

Further, the top portion 102 and the bottom portion 104 of the device case 100 may each independently comprise a transparent or optically clear material to allow for viewing, and optionally actuating, multiple screens or indicators. In an embodiment, one or both of the top portion 102 and the bottom portion 104 may independently comprise a touch-screen material, for example to accommodate a device having touch screens on multiple surfaces.

As best shown in FIGS. 4 and 6, the device case 100 may further include a flange 130 extending outwardly from either the top portion 102 or the bottom portion 104. The flange 130 may be removably coupled to, or alternatively, may be integrally formed with a portion of the device case 100, such as the bottom portion 104 for example. The flange 130 may be used to attach and secure the device case 100 to another object, such as a bicycle or a submersible, for example. The device case 100 may include a plurality of flanges 130, for example between 2 and 10 flanges, or between 3 and 8 flanges. The plurality of flanges 130 may be substantially identical, or different, and may, but need not be substantially aligned with one another. In the illustrated non-limiting embodiment of FIG. 4, the device case 100 includes a first flange 130A and a second flange 130B connected to the bottom portion 104 by a flange attachment 203. A pin 132 may cooperate with the at least one flange 130. For example, as shown in FIG. 4, the pin 132 may threadably engage an aperture 134 formed in the first and second flange 130A, 132B. The pin 132 may similarly extend through an aperture (not shown) formed in a portion of an object to which the device case 100 is to be coupled to restrict movement of the device case 100 relative to the object.

In an embodiment, the clasp 112, the lock 114, the hinge 108, the flange 130, and the pin 132 may each independently comprise any suitable material, and may comprise a metal, a polymeric material, or a combination thereof. Representative materials for the clasp 112, the lock 114, the hinge 108, the flange 130, and the pin 132, may be the same as those disclosed for the frame 120, or alternatively, may be independently selected.

The device case 100 may further include a button 140 configured to actuate a contact 26 of a device 20 housed within the cavity of the case 100. The button 140 may be provided on one or both of the top portion 102 and the bottom portion 104. Each button 140 can be configured to sealingly extend, e.g., movably protrude, into a portion of the device case 100 to actuate a corresponding contact 26 of a device 20 disposed within the case 100.

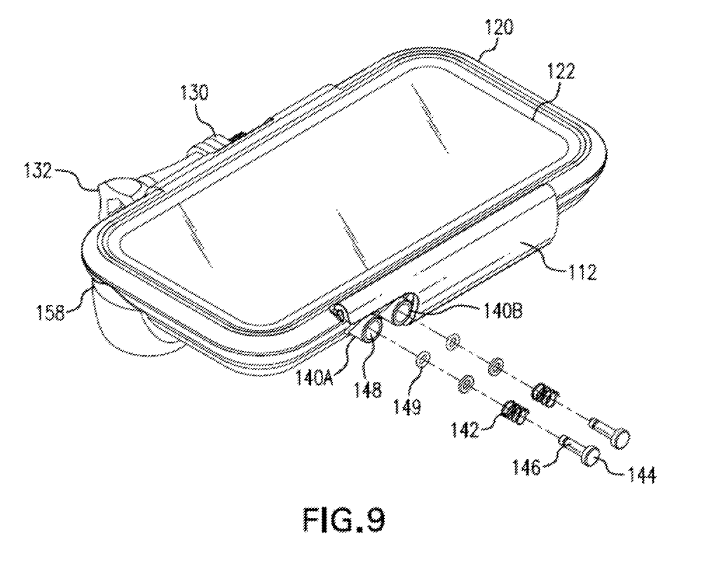

Embodiments of the device case 100 including a plurality of buttons 140 are also within the scope of the disclosure. For example, the device case 100 may have between 1 and 10, between 2 and 8, or between 3 and 6 buttons. In the non-limiting embodiment of FIGS. 5 and 9, the device case 100 includes a first button 140A and a second button 140B. As shown in the exploded view of FIG. 9, each button 140 may comprise a biasing member 142, e.g., a spring, to bias the button 140 between a rest position and an actuated position. Each button 140 may further comprise at least one of a compliant cover 144, a plunger 146, a sleeve 148, and a seal 149. The material of the compliant cover 144 and the seal 149 may be independently selected and may comprise any suitable material. Examples of materials that may be used to form at least one of the compliant cover 144 and the seal 149 include, but are not limited to, a silicone, a nitrile, nitrile butadiene, a polyacrylate acrylic rubber, a flouroelastomer, a polyurethane, a polyethylene, a polypropylene, a polypropylene-ethylene propylene dienene monomer, a butadiene, a styrene butadiene, a chlorosulfonate, a neoprene, butyl rubber, ethylene propylene, an ethylene propylene dienene monomer rubber (EPDM), a polyisoprene, polybutadiene, chloroprene, or any combination thereof for example.

The button 140 is additionally configured to maintain the watertight seal of the cavity 106 when the device case 100 is in the closed configuration. For example, the one or more buttons 140 may be configured to maintain a watertight seal from a depth of about 0 meters (i.e., splash protection) to a depth of about 50 meters, a depth of about 0.0001 meters to a depth of about 30 meters, a depth of about 0.001 meter to a depth of about 25 meters, a depth of about 0.01 meter to a depth of about 20 meters, a depth of about 0.1 meter to a depth of about 15 meters, or a depth of about 0.5 meter to a depth of about 5 meters. In an embodiment, the button 140 maintains a watertight seal to a depth of at least 50 meters, at least 30 meters, or to a depth of 2 meters.

An attachment 150 may extend from the device case 100, such as the top portion 102 or the bottom portion 104 for example. The attachment 150 may be integrally formed with the case 100, or alternatively, may be removable and interchangeable with a plurality of other attachments. When the attachment 150 is separable from the device case 100, an opening 152 (see FIG. 12) may be formed in the device case 100 such that the attachment 150 is receivable within or about the opening 152. In such embodiments, the attachment 150 forms a watertight seal with the device case 100.

In embodiments where the device configured for use with the device case 100 includes a camera lens, an attachment 150 may extend from either the top portion 102 or the bottom portion 104 of the device case 100 adjacent the camera lens. In such embodiments, the attachment 150 includes an optical lens 154 arranged in substantial alignment with the camera lens. The optical lens 154 may be directly connected to the case 100, or the attachment 150 may further include a lens mount 156 for supporting the optical lens 154. In an embodiment, the lens mount 156 is configured to support one of a plurality of interchangeable optical lenses 154. In a representative embodiment, the optical lens 154 is configured to provide a field of view of 90 to 180 degrees)(°, 100 to 170 degrees, or 110 to 160 degrees. In an embodiment, the optical lens 154 has a field-of-view of 165 to 180° is mentioned.

In addition, the attachment 150 may include a filter holder 158 configured to hold a filter (not shown), such as a red filter for example, over the top portion 102, the bottom portion 104, the optical lens 154, or a combination thereof. In an embodiment, the optical lens 154, the filter disposed in the filter holder, or combination thereof, may be colored, for example having a color which is selected to correct for a chromatic aberration. In an embodiment in which the device case 100 is to be used underwater, the optical lens 154 or filter, may have a color selected to compensate for the absorption of light in water. In addition, a lens cover (not shown) may be optionally provided to protect the optical lens 154 from being scratched. The lens cover may comprise any suitable material, e.g., as is disclosed for the frame 120. In an embodiment a lens cover comprising acrylonitrile butadiene styrene (ABS) is provided. In another embodiment, the lens cover is a clear lens, thereby providing an inexpensive optically clear lens protector that can be replaced if scratched or otherwise damaged.

Cold temperatures can negatively impact the operation of the device 20. For example, certain devices 20 utilize batteries which provide reduced runtime at cold temperatures. Therefore, it may be desirable to maintain a temperature of the device 20 disposed within the cavity 106 of the case 100. Optionally provided on an inner surface of the top portion 102 and the bottom portion 104 is an insulator. Any suitable insulator may be used. Representative materials for the insulator include an aerogel, a xerogel, fiberglass, organic polymeric fibers, silica fibers, quartz fibers, organic resin-based fibers, carbon fibers, elastomers, thermoset polymers, thermoplastic polymers, and composites (e.g., fiber-reinforced polymers), or a combination thereof. Examples of commercially available aerogel materials in are those supplied under the tradename of Nanogel® by Cabot Corporation, Billerica, Mass. Representative polymers include a polyolefin such as polypropylene (PP) or polyethylene (PE), a poly(meth)acrylate, a polyacrylonitrile, a polyacrylamide, or a polymethyl methacrylate a polyvinyl alcohol, polyvinyl acetate, polyvinyl stearate, polyvinyl benzoate, polyvinyl maleate, polyvinyl butyral, polyallyl phthalate or polyallylmelamine, a polyurea, a polyimide, a polyamide-imide, a polyester, polyethyleneterephthalate (PET), a polyamide (PA), a polycarbonate, a polyurethanes (PUR), a polyether, polychloroprene, a chlorinated rubber, a polyvinyl chloride (PVC), or a combination thereof.

For the window 122, the insulator is desirably transparent. Representative transparent insulators to be used on the window 122 include an aerogel, xerogel, or a combination thereof. A hydrophobic ormosil aerogel is specifically mentioned. In an embodiment including the insulator, the device case may be suitable for use at an ambient temperature of −40° C. to 40° C., −35° C. to 30° C., −20° C. to 30° C., −10° C. to 28° C., or −5° C. to 26° C.

The device case 100 may further optionally include a positioning member 160, as shown in FIG. 5, which may be removably arranged on an inner surface of the bottom portion 104, within the cavity 106. In an embodiment, the positioning member 160 may include an edge portion configured to contact a side of the device 20. The positioning member 160 may be configured to position a screen of the device adjacent an inner surface of the window 122 when positioned within the cavity 106.

Also, the device case 100 may further include a shock absorbing member 162. One or both of the positioning member 160 and the shock absorbing member 162 may provide shock absorbing properties and position the device 20 in the case so that button 140 of the device case 100 aligns with a corresponding contact 26 of the device 20. The positioning member 160 and the shock absorbing member 162 may each independently comprise an elastomer, a foam, a composite matrix, or a combination thereof. Representative elastomers include butadiene rubber, butyl rubber, chlorinated polyethylene, crosslinked polyethylene, chlorosulfonated polyethylene, epichlorohydrin-ethylene oxide, ethylene propylene diene terpolymer, ethylene-propylene rubber, ethylene-vinyl acetate (EVA), natural rubber, nitrile rubber, polyacrylate, polymethylmethacrylate, polychloroprene, polyisoprene, polypropylene oxide, polyurethane, silicone, styrene butadiene rubber, and thermoplastic elastomers. Representative foams include polymer foams that can be closed cell, microcellular, and open cell. Some representative crosslinked polymers include polystyrene, polyvinyl chloride, polyamino acids, proteins, polyethylene, polycarbonate, polyester, nylon, phenolic, polymethacrylimide, and polyethersulfone. Representative composite matrix materials include polyimides, liquid crystal polymers such as liquid crystal polyesters and liquid crystal polyaramides, epoxies, polyamides, polyaramides, polyethers such as polyether ether ketone (PEEK) and poly(ethylene terephthalate) (PET), and polyarylethers such as bisphenol and cyanate ester. A combination comprising at least one of the foregoing may be used.

The device 20 configured for use with the device case 100, such as a mobile device for example, can comprise one or more of a sensor, a touch-sensitive screen, and other electronic components that may be sensitive to damage from their environment, such as from liquids such as water coming in contact with the mobile device. The device case 100 allows use of the device 20 in a wet or otherwise device-incompatible environment without damage to the device 20. In an embodiment, the device 20 may be placed inside the cavity 106 of the device case 100, and the device case 100 closed around the device 20 to form a water-tight seal, thereby allowing for use of the device 20 in a wet environment without damage. This is beneficial because the device case 100 protects the device 20 from everyday spills and mishaps, and further allows for use of the device 20 underwater, e.g., to take photographs or videos underwater.

Also disclosed is a method of operating a device 20, the method comprising: positioning a device 20 in the device case 100; and actuating a button 140 from a rest position to an actuated position to actuate the device 20. The positioning of the device 20 within the device case 100 may comprise placing the device 20 in the cavity 106, closing the device case 100 so that the top portion 102 and the bottom portion 104 are arranged in overlapping contact such that the gasket 110 forms a watertight seal, and securing the device case 100 in the closed configuration with the at least one clasp 112. Also, the clasp 112 may be secured by engaging the lock 114. In an embodiment in which the lock 114 is a sliding lock, the lock 114 may be engaged by sliding the lock into contact with the clasp 112. Because the device case 100 is waterproof, once closed, it may be submerged in water or another fluid without damage to the device 20.

In an embodiment in which a button 140 of the device case 100 aligns with a contact 26 of the device 20, such as a volume button of the device 20, for example, actuating the button 140 from a rest position to an actuated position causes the plunger 146 of the button 140 to contact the volume button. In an embodiment in which the device 20 is programed so that the volume button controls a feature of the device 20, such as a camera thereof for example, depressing the button 140 can result in actuation of the camera. In another embodiment, the device 20 may be programed so that a first volume button scrolls through various features and a second volume button selects the feature. Accordingly, depressing a first button 140A aligned with the first volume button allows a user to select a feature when in a wet environment, and depressing the second button 140B causes selection of the selected feature, such as actuating the camera to take a picture or for starting and stopping the camera for videography, for example. Although the contacts 26 of the device 20 are illustrated and described herein as volume buttons, it should be understood that contact 140 may be configured to cooperate with any suitable contact 26 of the device 20.

Also disclosed is a system comprising the device case 100 and a device 20. The device 20 may be disposed in the device case 100, and at least one button 140 of the device case 100 may be aligned with a corresponding contact 26 of the device 20. In an embodiment, the device case 100 may comprise a first button 140A and a second button 140B, and the first button 140A may be aligned with a contact 26, e.g., a volume up contact, of the device, and the second button 140B may be aligned with a second contact 26, e.g., a volume down contact, of the device 20. Also, the optical lens 154 of the device case 100, which may be disposed in at least one of the top portion 102 and the bottom portion 104, may be aligned with a camera lens 28 of the device 20. By aligning a button 140 with the contact 26, in an embodiment in which the device 20 is programmed so that the volume button actuates the camera, the camera may be controlled and actuated by contacting the button to displace a plunger 146 of the button 140 from a rest position to an actuated position to actuate the contact 26. In an embodiment, the system may be an underwater photography system, and may be an underwater photography system or an underwater videography system. In certain configurations, the system may be a dive management system, or system for confined-space management. In each of the systems, the device may be programed so that desired features may be accessed and actuated using the volume button(s), which may be contacted by pressing on the corresponding button of the case.

Also disclosed is a system comprising a device case 100 including interchangeable first and second top portions 102A and 102B which are configured to provide a watertight seal to varying depths. In an embodiment, the first top portion 102A may provide a watertight seal to a depth of 50 meters, a depth of at least 30 meters, a depth of 0.001 meter to a depth of 25 meters, or a depth of 0.01 meter to a depth of 20 meters, and does not have touch-screen functionality. The second top portion 102B may provide a watertight seal to a depth of at least 2 meters, a depth of 0.001 meter to a depth of 1 meter, or a depth of 0.01 meter to a depth of 0.5 meters and has touch-screen functionality. By providing the interchangeable first and second top portion 102A and 102B, a user will have the ability to use the first top portion 102A when use of the device 20 at a depth of greater than 2 meters is anticipated, and may switch to the second top portion 102B when use of the device at a depth of less than 2 meters is anticipated and/or when touch-screen functionality is desired.

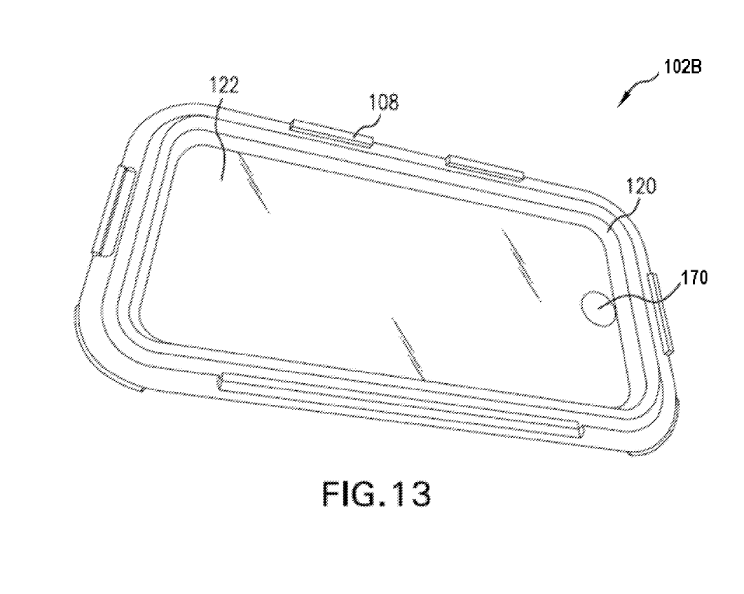

The first top portion 102A, illustrated in FIGS. 3-12, and the second top portion 102B, shown in FIG. 13, have a similar construction including a frame 120 and a transparent window 122. However, a thickness of the top portion 102, particularly of the window 122, varies between the interchangeable first and second top portions 102A and 102B and contributes to the difference in the allowable depths at which the device case 100 provides a watertight seal. In an embodiment, a thickness of the window 122 of the first top portion 102A is between 0.01 millimeter (mm) to 5 mm, 0.5 mm to 4 mm, or 1 mm to 3 mm, and a thickness of the window 122 of the second top portion 102B is between 0.01 mm to 1 mm, 0.1 mm to 0.7 mm, or 0.15 mm to 0.4 mm. An embodiment in which the a thickness of the window 122 of the first top portion 102A is 2.5 mm, and an embodiment in which a thickness of the window 122 of the second top portion 102B is 0.2 mm are specifically mentioned. As a result of its reduced thickness, the second top portion 102B has touch screen functionality such that a user may operate an adjacent touch screen of a device 20 within the device case 100 by contacting the window 122 thereof. In an embodiment, the second top portion 102B includes a contactor 170 extending through the second top portion 102B configured to engage a corresponding contact 26 on the surface of the screen 24 of the device 20. The contactor 170 may be formed from a plastic or another suitable material.

In an embodiment, a device case comprises: a top portion 102 and a bottom portion 104, wherein at least one of the top portion 102 and the bottom portion 104 comprises a gasket 110 configured to sealingly contact the top portion 102 and the bottom portion 104, and a button 140, which is configured to sealingly extend into the at least one of the top portion 102 and the bottom portion 104; and a clasp 112, which is configured to reversibly hold the top portion 102 and the bottom portion 104 in a closed configuration.

In another embodiment disclosed is a method of operating a device 20, the method comprising: disposing a device 20 in the device case 100; and actuating a button 140 from a rest position to an actuated position to actuate the device 20.

In another embodiment a system comprises: the device case 100 and a device 20.

In another embodiment, a device case 100 comprises a top portion 102 and a bottom portion 104, wherein at least one of the top portion 102 and the bottom portion 104 comprises a gasket 110 configured to sealingly contact the top portion 102 and the bottom portion 104, and a first button 140A and a second button 140B, each of which is configured to independently sealingly extend into the at least one of the top portion 102 and the bottom portion 104; a clasp 112, which is configured to reversibly hold the top portion 102 and the bottom portion 104 in a closed configuration; a lock 114, which is configured to lock the clasp 112; a hinge 108, which hingably connects the top portion 102 and the bottom portion 104; an optical lens 154 disposed in at least one of the top portion 102 and the bottom portion 104; and a flange 130 disposed on a side of the device case 100, wherein the device case 100 is watertight to a depth of at least 30 meters.

In the various embodiments (i) at least one of the top portion 102 and the bottom portion 104 comprises a polycarbonate; and/or (ii) at least one of the top portion 102 and the bottom portion 104 comprises an acrylonitrile-butadiene-styrene polycarbonate blend; and/or (iii) the gasket 110 is configured to seal the top portion 102 and the bottom portion 104; and/or (iv) the gasket 110 maintains a watertight seal to a depth of at least 2 meters; and/or (v) the gasket maintains a watertight seal to at least a depth of 50 meters; and/or (vi) the gasket 110 comprises a silicone, a nitrile, nitrile butadiene, a polyacrylate acrylic rubber, a flouroelastomer, a polyurethane, a polyethylene, a polypropylene, a polypropylene-ethylene propylene diene monomer, a butadiene, a styrene butadiene, a chlorosulfonate, a neoprene, butyl rubber, ethylene propylene, an ethylene propylene diene monomer rubber (EPDM), a polyisoprene, polybutadiene, chloroprene, or combination thereof; and/or (vii) the button 140 is configured to movably protrude into the at least one of the top portion 102 and the bottom portion 104; and/or (viii) the button 140 further comprises a biasing member 142, which biases a position of the button 140 between a rest position and an actuated position; and/or (ix) the biasing member 142 is a spring; and/or (x) the button 140 comprises a compliant cover 144; and/or (xi) the compliant cover 144 comprises a silicone, a nitrile, nitrile butadiene, a polyacrylate acrylic rubber, a flouroelastomer, a polyurethane, a polyethylene, a polypropylene, a polypropylene-ethylene propylene diene monomer, a butadiene, a styrene butadiene, a chlorosulfonate, a neoprene, butyl rubber, ethylene propylene, an ethylene propylene diene monomer rubber (EPDM), a polyisoprene, polybutadiene, chloroprene, or combination thereof; and/or (xii) the button comprises a plunger; and/or (xiii) the button 140 maintains a watertight seal to at least a depth of 2 meters; and/or (xiv) the button maintains a watertight seal to at least a depth of 50 meters; and/or (xv) the device case 100 comprises a plurality of buttons 140; and/or (xvi) the device case 100 further comprises a lock 114, which is configured to lock the clasp 112 in a closed position; and/or (xvii) the device case 100 comprises a plurality of clasps 112; and/or (xviii) the device case 100 further comprises a plurality of locks 114, each of which is configured to lock a corresponding clasp 112 of the plurality of clasps 112; and/or (xix) the plurality of clasps 112 comprises a first clasp 112A disposed on a first side of the top portion 102 or the bottom portion 104, and a second clasp 112B disposed on an opposite second side of the top portion 102 or the bottom portion 104; and/or (xx) the device case 100 further comprises a first lock 114A configured to lock the first clasp 112A, and a second lock 114B configured to lock the second clasp 112B; and/or (xxi) the plurality of clasps 112 comprises a third clasp 112C disposed on a third side of the top portion 102 or the bottom portion 104, and a fourth clasp 112D disposed on an opposite fourth side of the of the top portion 102 or the bottom portion 104; and/or (xxii) the device case 100 further comprises a third lock 114C configured to lock the third clasp 112C, and a fourth lock 114D configured to lock the fourth clasp 112D; and/or (xxiii) the device case 100 further comprises a hinge 108, which connects the top portion 102 and the bottom portion 104; and/or (xxix) the hinge 108 is disposed on a side of the top portion 102 or the bottom portion 104 and opposite the clasp 112; and/or (xxx) the hinge 108 is disposed on a third side of the of the device case 100, wherein the third side is adjacent the first and second sides; and/or (xxxi) the device case 100 does not comprise a hinge 108; and/or (xxxii) the device case 100 further comprises a flange 130 disposed on a side of the device case 100; and/or (xxxiii) the device case 100 further comprises an insulator disposed on an inner surface of at least one of the top portion 102 and the bottom portion 104; and/or (xxxiv) the insulator comprises an aerogel; and/or (xxxv) the device case 100 further comprises an optical lens 154 disposed in at least one of the top portion 102 and the bottom portion 104; and/or (xxxvi) the optical lens 154 is configured to provide a field-of-view of 165 to 180 degrees; and/or (xxxvii) the device case 100 further comprises a lens mount 156 on the at least one of the top portion 102 and the bottom portion 104, and wherein the optical lens 154 is removably attached to the lens mount 156; and/or (xxxviii) the lens mount 156 is removably attached to the at least one of the top portion 102 and the bottom portion 104; and/or (xxxix) the device case 100 further comprising a filter holder 158, wherein the filter holder is disposed on the top portion 102, the bottom portion 104, the optical lens 154, or combination thereof; and/or (xl) the top portion 102 and the bottom portion 104 are removably attached; and/or (xli) the device case 100 further comprises a positioning member 160, wherein the positioning member 160 is configured to position a screen 24 of a device 20 disposed in the device case 100 adjacent an inner surface of the window 122; and/or (xlii) at least one of the top portion 102 and the bottom portion 104 comprises a touch screen sensitive glass; and/or (xliii) the actuating actuates a contact 26 of the device 20; and/or (xliv) the actuating comprises contacting a contact 26 of the device 20 with a plunger 146 of the button 140; and/or (xlv) the method further comprises closing the device case 100, wherein the closing comprises positioning the clasp 112 in a closed position; and/or (xlvi) the method further comprises submerging the closed device case 100 underwater after the closing and before the actuating; and/or (xlvii) the device 20 is disposed in the device case, and wherein the button 140 of the device case 100 is aligned with a contact 26 of the device 20; and/or (xlviii) the system comprises a first button 140A and a second button 140B, wherein the first button 140A is aligned with a first contact 26 of the device 20, and the second button 140B is aligned with a second contact 26 of the device 20; and/or (xlix) the device case 100 further comprises an optical lens 154 disposed in at least one of the top portion 102 and the bottom portion 104, and wherein the optical lens 154 is aligned with a camera lens 28 of the device 20; and/or (xlx) the camera lens 28 of the device 20 is actuated by contacting the button 140; and/or (xlxi) the optical lens 154 provides the camera lens 28 an angle of view of up to 180°; and/or (xlxii) the optical lens 154 provides the camera lens 28 an angle of view of 30° to 180°; and/or (xlxiii) the system is an underwater photography system; and/or (xlxiv) the underwater photography system is an underwater videography system; and/or (xlxv) the system is a dive management system; and/or (xlxvi) the system is a confined-space management system.

In this disclosure some but not all embodiments of this disclosure are described. This disclosure may be embodied in many different forms and is not be construed as limited to the embodiments set forth herein; rather, these embodiments are provided so that this disclosure will fully convey the scope of the invention to those skilled in the art.

It will be understood that when an element is referred to as being “on” another element, it can be directly on the other element or intervening elements may be present there between. In contrast, when an element is referred to as being “directly on” another element, there are no intervening elements present.

It will be understood that, although the terms “first,” “second,” “third,” etc., may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second element, component, region, layer or section without departing from the teachings herein.

The terminology used herein is for the purpose of describing particular embodiments only and is not intended to be limiting. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

What is claimed is:

1. A device case comprising:
a top portion and a bottom portion, wherein at least one of the top portion and the bottom portion comprises
a gasket configured to sealingly contact the top portion and the bottom portion, and
a button, which is configured to sealingly extend into the at least one of the top portion and the bottom portion; and
a clasp, which is configured to reversibly hold the top portion and the bottom portion in a closed configuration.

2. The device case of claim 1, wherein at least one of the top portion and the bottom portion comprises a polycarbonate.

3. The device case of any of claims 1-2, wherein at least one of the top portion and the bottom portion comprises an acrylonitrile-butadiene-styrene polycarbonate blend.

4. The device case of any of claims 1-3, wherein the gasket is configured to seal the top portion to the bottom portion.

5. The device case of any of claims 1-4, wherein the gasket maintains a watertight seal to a depth of at least 2 meters.

6. The device case of any of claims 1-5, wherein the gasket maintains a watertight seal to a depth of at least 50 meters.

7. The device case of any of claims 1-6, wherein the gasket comprises a silicone, a nitrile, nitrile butadiene, a polyacrylate acrylic rubber, a flouroelastomer, a polyurethane, a polyethylene, a polypropylene, a polypropylene-ethylene propylene dienene monomer, a butadiene, a styrene butadiene, a chlorosulfonate, a neoprene, butyl rubber, ethylene propylene, an ethylene propylene dienene monomer rubber (EPDM), a polyisoprene, polybutadiene, chloroprene, or combination thereof.

8. The device case of any of claims 1-7, wherein the button is configured to movably protrude into the at least one of the top portion and the bottom portion.

9. The device case of any of claims 1-8, wherein the button further comprises a biasing member, which biases a position of the button between a rest position and an actuated position.

10. The device case of any of claims 1-9, wherein the biasing member is a spring.

11. The device case of any of claims 1-10, wherein the button comprises a compliant cover.

12. The device case of any of claims 1-11, wherein the compliant cover comprises a silicone, a nitrile, nitrile butadiene, a polyacrylate acrylic rubber, a flouroelastomer, a polyurethane, a polyethylene, a polypropylene, a polypropylene-ethylene propylene dienene monomer, a butadiene, a styrene butadiene, a chlorosulfonate, a neoprene, butyl rubber, ethylene propylene, an ethylene propylene dienene monomer rubber, a polyisoprene, polybutadiene, chloroprene, or combination thereof.

13. The device case of any of claims 1-12, wherein the button comprises a plunger.

14. The device case of any of claims 1-13, wherein the button maintains a watertight seal to at least a depth of 2 meters.

15. The device case of any of claims 1-14, wherein the button maintains a watertight seal to at least a depth of 50 meters.

16. The device case of any of claims 1-15, comprising a plurality of buttons.

17. The device case of any of claims 1-16, further comprising a lock, which is configured to lock the clasp in a closed position.

18. The device case of any of claims 1-17, wherein the device case comprises a plurality of clasps.

19. The device case of any of claims 1-18, further comprising a plurality of locks, each of which is configured to lock a corresponding clasp of the plurality of clasps.

20. The device case of any of claims 1-19, wherein the plurality of clasps comprises a first clasp disposed on a first side of the top portion or the bottom portion, and a second clasp disposed on an opposite second side of the top portion or the bottom portion.

21. The device case of any of claims 1-20, further comprising a first lock configured to lock the first clasp, and a second lock configured to lock the second clasp.

22. The device case of any of claims 1-21, wherein the plurality of clasps further comprises a third clasp disposed on a third side of the top portion or the bottom portion, and a fourth clasp disposed on an opposite fourth side of the of the top portion or the bottom portion.

23. The device case of any of claims 1-22, further comprising a third lock configured to lock the third clasp, and a fourth lock configured to lock the fourth clasp.

24. The device case of any of claims 1-23, further comprising a hinge, which connects the top portion and the bottom portion.

25. The device case of any of claims 1-24, wherein the hinge is disposed on a side of the top portion or the bottom portion and opposite the clasp.

26. The device case of any of claims 1-25, wherein the hinge is disposed on a third side of the of the device case, wherein the third side is adjacent the first and second sides.

27. The device case of any of claims 1-26, wherein the device case does not comprise a hinge.

28. The device case of any of claims 1-27, further comprising a flange disposed on a side of the device case.

29. The device case of any of claims 1-28, further comprising an insulator disposed on an inner surface of at least one of the top portion and the bottom portion.

30. The device case of any of claims 1-29, wherein the insulator comprises an aerogel.

31. The device case of any of claims 1-30, further comprising an optical lens disposed in at least one of the top portion and the bottom portion.

32. The device case of any of claims 1-31, wherein the optical lens is configured to provide a field-of-view of 165 to 180 degrees.

33. The device case of any of claims 1-32, further comprising a lens mount on at least one of the top portion and the bottom portion, and wherein the optical lens is removably attached to the lens mount.

34. The device case of any of claims 1-33, further comprising a lens mount on at least one of the top portion and the bottom portion, and wherein the lens mount is removably attached to the at least one of the top portion and the bottom portion.

35. The device case of any of claims 1-34, further comprising a filter holder, wherein the filter holder is disposed on the top portion, the bottom portion, the optical lens, or combination thereof.

36. The device case of any of claims 1-35, wherein the top portion and the bottom portion are removably attached.

37. The device case of any of claims 1-36, further comprising a positioning member, wherein the positioning member is configured to position a screen of a device disposed in the case adjacent an inner surface of the window.

38. The device case of any of claims 1-37, wherein at least one of the top portion and the bottom portion comprises a touch screen sensitive glass.

39. A method of operating a device, the method comprising:
disposing a device in the device case of any of claims 1-38; and
actuating the button from a rest position to an actuated position to actuate the device.

40. The method of claim 39, wherein the actuating actuates a volume button of the device.

41. The method of any of claims 39-40, wherein the actuating comprises contacting a volume contact of the device with a plunger of the button.

42. The method of any of claims 39-41, wherein the device is programed so that the contacting of the volume contact scrolls through various features, and contacting a second volume contact selects the feature.

43. The method of any of claims 39-42, further comprising closing the device case, wherein the closing comprises positioning the clasp in a closed position.

44. The method of any of claims 39-43, further comprising submerging the closed device case underwater after the closing and before the actuating.

45. A system comprising:
the device case of any of claims 1-38; and
a device disposed in the case.

46. The system of claim 45, wherein the device is disposed in the device case, and wherein the button of the device case is aligned with a volume button of the device.

47. The system of any of claims 45-46, comprising a first button and a second button, wherein the first button is aligned with a first volume contact of the device, and the second button is aligned with a second volume contact of the device.

48. The system of any of claims 45-47, wherein the device case further comprises an optical lens disposed in at least one of the top portion and the bottom portion, and wherein the optical lens is aligned with a camera of the device.

49. The system of any of claims 45-48, wherein the camera of the device is actuated by contacting the button.

50. The system of any of claims 45-49, wherein the optical lens provides the camera an angle of view of up to 180°.

51. The system of any of claims 45-50, wherein the optical lens provides the camera an angle of view of 30° to 180°.

52. The system of any of claims 45-51, wherein the system is an underwater photography system.

53. The system of any of claims 45-52, wherein the underwater photography system is an underwater videography system.

54. The system of any of claims 45-53, wherein the system is a dive management system.

55. The system of any of claims 44-54, wherein the system is a confined-space management system.

56. The system of any of claims 44-55, wherein the device is programed so that contacting the first volume button scrolls through various features, and contacting a second volume button selects the feature.

57. A device case comprising:
a top portion and a bottom portion, wherein at least one of the top portion and the bottom portion comprises
a gasket configured to sealingly contact the top portion and the bottom portion, and
a first button and a second button, each of which is configured to independently sealingly extend into the at least one of the top portion and the bottom portion;
a clasp, which is configured to reversibly hold the top portion and the bottom portion in a closed configuration;
a lock, which is configured to lock the clasp;
a hinge, which hingably connects the top portion and the bottom portion;
an optical lens disposed in at least one of the top portion and the bottom portion; and
a mounting arm disposed on a side of the device case,
wherein the device case is watertight to a depth of at least 30 meters.
